(19) United States
(12) Patent Application Publication
(10) Pub. No.: US 2026/0281360 A1
(43) Pub. Date: Sep. 17, 2026

(54) METHODS AND APPARATUS FOR VIDEO CODING USING MULTIPLE HYPOTHESIS CROSS-COMPONENT PREDICTION FOR CHROMA CODING

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,687

(22) PCT Filed: Aug. 1, 2024
(86) PCT No.: PCT/CN2024/109215

§ 371 Date: Oct. 5, 2025

Related U.S. Application Data
(60) Provisional application No. 63/516,880, filed on Aug. 1, 2023.

(51) Int. Cl. H04N 19/132; H04N 19/159; H04N 19/176; H04N 19/186

(52) U.S. Cl. CPC H04N 19/132; H04N 19/159; H04N 19/176; H04N 19/186

(57) ABSTRACT

A method and apparatus for coding colour pictures or video using coding tools including one or more cross component models related modes are disclosed. According to this method, input data associated with a current block comprising a first-colour block and a second-colour block is received. Two or more candidates are derived, wherein said two or more candidates comprise one or more candidate CCP (Cross-Component Prediction) models. One or more MH (Multiple Hypothesis) candidates are generated by blending two or more hypotheses of prediction associated with said two or more candidates. The second-colour block is encoded or decoded by using prediction data comprising said one or more MH candidates.

### CROSS REFERENCE TO RELATED APPLICATIONS

The present invention is a non-Provisional Application of and claims priority to U.S. Provisional Patent Application No. 63/516,880, filed on Aug. 1, 2023. The U.S. Provisional Patent Application is hereby incorporated by reference in its entirety.

### FIELD OF THE INVENTION

The present invention relates to video coding system. In particular, the present invention relates to coding for a chroma component using multiple hypotheses of cross-component prediction models.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In order to improve the coding performance for a system using cross-component models, methods and apparatus of multiple hypotheses of cross-component prediction models for chroma blocks are disclosed.

### BRIEF SUMMARY OF THE INVENTION

A method and apparatus for coding colour pictures or video using coding tools including one or more cross component models related modes are disclosed. According to this method, input data associated with a current block comprising a first-colour block and a second-colour block is received, wherein the input data comprise pixel data to be encoded at an encoder side or data associated with the current block to be decoded at a decoder side. Two or more candidates are derived, wherein said two or more candidates comprise one or more candidate CCP (Cross-Component Prediction) models. One or more MH (Multiple Hypothesis) candidates are generated by blending two or more hypotheses of prediction associated with said two or more candidates. The second-colour block is encoded or decoded by using prediction data comprising said one or more MH candidates.

In one embodiment, one or more hypotheses of prediction with smaller template costs are selected from two or more candidate hypotheses of prediction as said one or more of said two or more hypotheses of predictions associated with said two or more candidates. In one embodiment, said two or more hypotheses of prediction associated with said two or more candidates are blended using a weighting scheme. In one embodiment, the weighting scheme depends on template costs of said two or more hypotheses of prediction associated with said two or more candidates. In one embodiment, one hypothesis of prediction with smaller template cost is assigned a higher weighting. In one embodiment, weights for the weighting scheme are calculated using a lookup table.

In one embodiment, when said two or more hypotheses of prediction are selected from different template regions, the weighting scheme depends on positions of different samples. In one embodiment, a current sample in the current block derives own weighting scheme for said two or more hypotheses of prediction depending on a distance between a target template region and the current sample. In one embodiment, when a current sample is closer to a top template or a left template, a target hypothesis of prediction suggested by the top template or the left template respectively gets a higher weight. In one embodiment, when one of said two or more hypotheses of prediction has a large template cost, position-dependent weighting is further adjusted to reduce a weight for said one of said two or more hypotheses of prediction with the large template cost.

In one embodiment, whether to generate said one or more MH candidates for encoding or decoding depends on one or more enabling conditions. In one embodiment, when said one or more enabling conditions are not satisfied, only one of said two or more hypotheses of prediction is used to form prediction data for the second-colour block.

In one embodiment, one MH candidate is used as an intra prediction. In one embodiment, when a value of said one MH candidate for the intra prediction exceeds a sample range, the value of said one MH candidate for the intra prediction is clipped to be within the sample range. In one embodiment, weighting used to form said one MH candidate for the intra prediction follows the weighting for TIMD (Template-based Intra Mode Derivation). In one embodiment, said one MH candidate for the intra prediction is further combined with an inter prediction.

In one embodiment, when a value of said one MH candidate for the intra prediction exceeds a sample range, the value of said one MH candidate for the intra prediction is not clipped to be within the sample range. In one embodiment, said one MH candidate for the intra prediction is further combined with an inter prediction to form a combined prediction. In one embodiment, the combined prediction is clipped to be within the sample range.

In one embodiment, decision on whether to apply inter CCLM or inter CCCM is separate for List0 prediction and List1 prediction of bi-prediction block.

In one embodiment, selection from said two or more hypotheses of prediction is separate for List0 prediction and List1 prediction of bi-prediction block.

In one embodiment, when OBMC mode is applied to the current block and if a neighbouring block of the current block is coded by any mode from cross-component modes and motion-compensated predictors, one or more of said two or more hypotheses of prediction are generated by using the cross-component modes of the neighbouring block to adjust predictors of the current block following the OBMC mode.

In one embodiment, when the one or more candidate CCP models belong to one or more specific CCP models, the costs for the one or more candidate CCP models are adjusted by increasing or decreasing the costs of the one or more candidate CCP models. In one embodiment, the one or more specific CCP models comprise GLM modes, any subset of GLM (Gradient Linear Model) modes, MDF (Multiple Downsampling Filters) modes, any subset of MDF modes, any combination thereof, or any subset of cross-component modes for intra prediction. In one embodiment, the costs are increased by adding a positive offset or scaling by a factor larger than 1.

In one embodiment, the one or more specific CCP models comprise one or more modes using non-down-sampled luma reference samples, CCRM (Cross-Component Residual Model), CCLM (Cross-Component Linear Model), MMLM (Multiple Model CCLM), any combination thereof, or any subset of cross-component modes for intra prediction. In one embodiment, the costs are decreased by subtracting a positive offset or scaling by a factor smaller than 1. In one embodiment, after the costs for the one or more candidate CCP models belonging to one or more specific CCP models are adjusted, order of the one or more candidate CCP models belonging to one or more specific CCP models in a list comprising said two or more candidates are adjusted based on the adjusted costs for the one or more candidate CCP models belonging to one or more specific CCP models to derive said two or more MH candidates.

In one embodiment, when the current block is inter coded, one or more specific CCP models are not allowed to be taken as any of the two or more candidates. In one embodiment, the one or more specific CCP models comprise GLM modes, any subset of GLM (Gradient Linear Model) modes, MDF (Multiple Downsampling Filters) modes, any subset of MDF modes, any combination thereof, or any subset of cross-component modes for intra prediction.

In one embodiment, when the current block is inter coded, one or more specific CCP models are allowed to be taken as any of the two or more candidates. In one embodiment, the one or more specific CCP models comprise one or more modes using non-down-sampled luma reference samples, CCRM (Cross-Component Residual Model), CCLM (Cross-Component Linear Model), MMLM (Multiple Model CCLM), any combination thereof, or any subset of cross-component modes for intra prediction.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows 16 gradient patterns for GLM.

FIG. 3 illustrates the 6-tap spatial terms corresponding to 6 neighbouring luma samples (i.e., L0, L1, . . . , L5) around the chroma sample (i.e., C) to be predicted for CCCM mode.

FIG. 4 shows an exemplary system block diagram for Cross-component residual model (CCRM).

FIG. 5 illustrates an example of template and its reference samples used in TIMD.

FIG. 6 illustrates the 5 neighbouring blocks used for deriving spatial merge candidates for VVC.

FIG. 7 illustrates an exemplary pattern of the adjacent and non-adjacent spatial merge candidates.

FIG. 8 illustrates an example of temporal candidate derivation, where a scaled motion vector is derived according to POC (Picture Order Count) distances.

FIG. 9 illustrate the positions for the temporal candidate selected between candidates C₀ and C₁.

FIG. 10 illustrates filters H(⋅), G1(⋅), G2(⋅), and G3(⋅) used by Multiple Downsampling Filters (MDF) for cross-component modes.

FIG. 11 illustrates the current chroma sample position C, and N, S, W, E, NE, SW are the down-sampled luma positions around C.

FIG. 12A-FIG. 12C illustrates various patterns of source term within an M×N window for luma.

FIG. 13 illustrates an example of Sobel filters to derive the gradient information of the collocated luma sample for the target chroma.

FIG. 14A-FIG. 14C illustrates various patterns of source term within an M2×N2 window for chroma.

FIG. 15 illustrates an example of the reference region of the current block comprising the spatial neighbouring region of the current block from above, left and above-left.

FIG. 16 illustrates a flowchart of an exemplary video coding system that incorporates multiple hypotheses of cross-component prediction models according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of cross-component prediction, various schemes are disclosed.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i,j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The terms of {LM_LA, LM_L, LM_A} and {CCLM_LT, CCLM_L, CCLM_T} are used interchangeably in this disclosure.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L}[x, y]<=Threshold is classified into group 1; while a neighbouring sample with Rec′_{L}[x, y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 2 )$$

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term.

Output of the filter is calculated as a convolution between the filter coefficients and the input values and clipped to the range of valid chroma samples.

The filter coefficients are calculated by minimising MSE between predicted and reconstructed chroma samples in the reference area.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

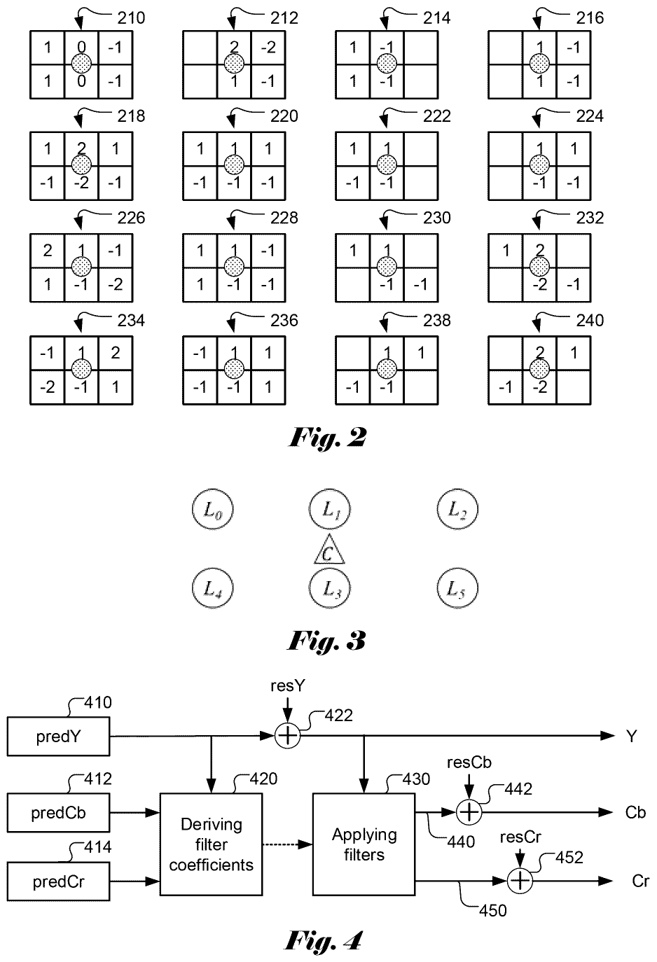

FIG. 2 shows the 16 gradient filters (210-240) for the gradient calculation.

### Intra Block Copy

Intra block copy (IBC) is a tool adopted in HEVC extensions on screen content coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### CCCM Using Non-Down-Sampled Luma Samples

CCCM mode with 3×2 filter using non-down-sampled luma samples is used, which consists of 6-tap spatial terms, four nonlinear terms and a bias term. The 6-tap spatial terms correspond to 6 neighbouring luma samples (i.e., L0, L1, . . . , L5) around the chroma sample (i.e., C) to be predicted, the four non-linear terms are derived from the samples L0, L1, L2, and L3 as shown as follows, where the locations of the non-down-sampled luma samples are shown in FIG. 3.

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) ≫ bitDepth ) + {α}_{10} \cdot β + offsetChroma$$

### Cross-Component Residual Model (CCRM)

As in JVET-AD0108 (Pekka Astola, et. al., “AHG12: Cross-component residual model (CCRM) for inter prediction”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), it is to apply cross-component residual model (CCRM) to predict chroma samples from reconstructed luma samples when the block uses inter prediction or intra block copy (IBC). FIG. 4 illustrates the decoder side of the method. The cross-component filters are derived using the prediction signals of luma and chroma. The derived filters are applied to the reconstructed luma signal producing the final chroma predictions. Filter coefficients are derived in step 420 for each chroma component separately using the prediction signals (i.e., predY 410, and predCb 412 or predCr 414) and the filters are applied to the reconstructed luma signal in step 430 as shown in FIG. 4. The reconstructed luma signal is formed by combining the luma prediction (PredY) 410 and residual luma signal (resY) using an adder 422. After applying the filters, the step 430 generates filtered-predicted Cb 440 and filtered-predicted Cr 450. The reconstructed Cb signal is formed by combining the filtered-predicted Cb 440 and residual Cb signal (i.e., resCb) using an adder 442. Similarly, the reconstructed Cr signal is formed by combining the filtered-predicted Cr 450 and residual Cr signal (i.e., resCr) using an adder 452.

### Chroma DM Mode

For Chroma DM mode, the intra prediction mode of the corresponding (collocated) luma block covering the centre position of the current chroma block is directly inherited.

Decoder Side Intra Mode derivation (DIMD)

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

### Template-Based Intra Mode Derivation (TIMD)

Template-based Intra Mode Derivation (TIMD) mode implicitly derives the intra prediction mode of a CU by using a neighbouring template at both the encoder and decoder, instead of signalling exact intra prediction mode bits to the decoder. As shown in FIG. 5, the prediction samples of the template are generated using the reference samples of the template for each candidate mode. A cost is calculated as the SATD between the prediction and the reconstructed samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list. As shown in FIG. 5, the prediction samples of the template (512 and 514) for the current block 510 are generated using the reference samples (520 and 522) of the template for each candidate mode.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

### Spatial Candidate Derivation

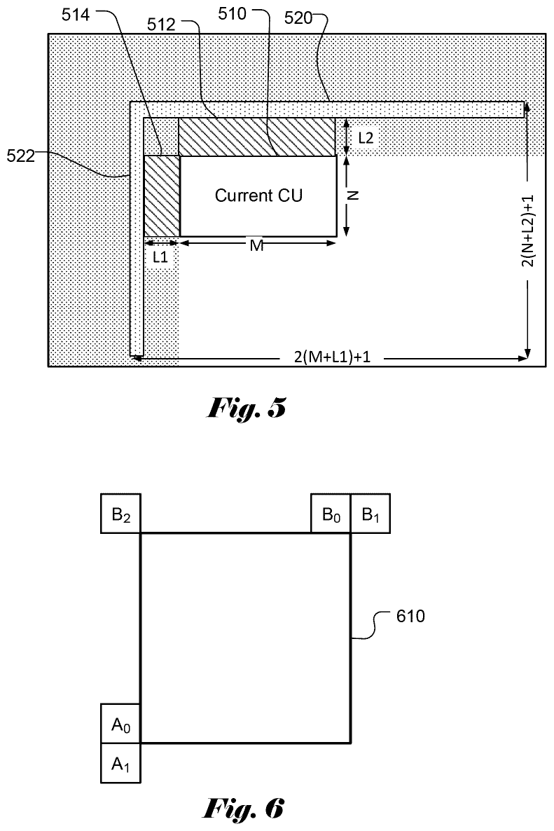

The derivation of spatial merge candidates in VVC is the same as that in HEVC except that the positions of first two merge candidates are swapped. A maximum of four merge candidates (B₀, A₀, B₁ and A₁) for current CU 610 are selected among candidates located in the positions depicted in FIG. 6. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₀ is added, the addition of the remaining candidates is subject to a redundancy check which ensures that candidates with the same motion information are excluded from the list so that coding efficiency is improved.

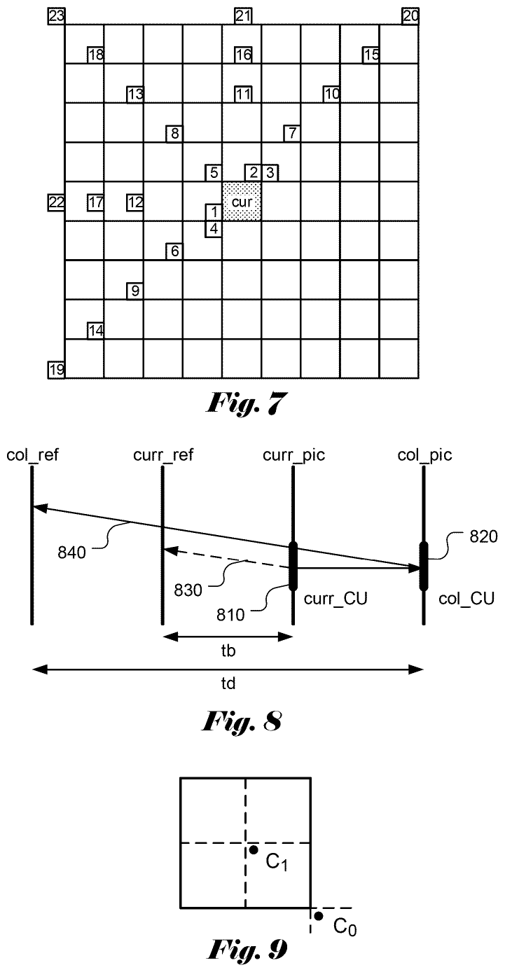

In addition to the above-mentioned spatial candidates, the non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. An example of the pattern of spatial merge candidates is shown in FIG. 7. The distances between non-adjacent spatial candidates and current coding block are based on the width and height of current coding block. The line buffer restriction is not applied.

### Temporal Candidates Derivation

In this step, only one candidate is added to the list. Particularly, in the derivation of this temporal merge candidate for a current CU 810, a scaled motion vector is derived based on the co-located CU 820 belonging to the collocated reference picture as shown in FIG. 8. The reference picture list and the reference index to be used for the derivation of the co-located CU is explicitly signalled in the slice header. The scaled motion vector 830 for the temporal merge candidate is obtained as illustrated by the dotted line in FIG. 8, which is scaled from the motion vector 840 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 9. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### OBMC (Overlapped Block Motion Compensation)

When OBMC is applied, top and left boundary pixels of a CU are refined using neighbouring block's motion information with a weighted prediction as described in JVET-L0101 (Zhi-Yi Lin, et. al., “CE10.2.1: OBMC”, Joint Video Experts Team (JVET) of ITU-T SG 16 WP 3 and ISO/IEC JTC 1/SC 29, 12th Meeting: Macao, CN, 3-12 Oct. 2018, Document: JVET-L0101).

Conditions of not applying OBMC are as follows:
When OBMC is disabled at SPS level
When current block has intra mode or IBC mode
When current luma block area is smaller or equal to 32

Additionally, OBMC is adaptively controlled on a block level as follows:
OBMC flag is inherited from a neighbouring affine block for affine merge mode.
OBMC is not applied to a block if there is a neighbour block coded with IBC, palette, or BDPCM modes.
When applying OBMC to a block, block boundary check on whether OBMC is applied to the boundary is further made based on the reference samples of the current block. If any absolute difference between the prediction sample and non-interpolated (integer pel) reference sample is greater than a threshold, the OBMC is not applied to that boundary.

A subblock-boundary OBMC is performed by applying the same blending to the top, left, bottom, and right subblock boundary pixels using neighbouring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIIP (Combined Inter-Intra Prediction) mode with LMCS (Luma Mapping with Chroma Scaling), inter blending is performed prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128}$$

$$PredY = \frac{( 4 - {w}_{0} ) \times FwdMap ( {Inter}_{predY}^{′} ) + {w}_{0} \times {Intra}_{predY}}{4} ,$$

where Inter_{predY} represents the samples predicted by the motion of current block in the original domain, Intra_{predY} represents the samples predicted in the mapped domain, OBMC_{predY} represents the samples predicted by the motion of neighbouring blocks in the original domain, and w₀ and w₁ are the weights.

When OBMC mode is used in a LIC (Local Illumination Compensation) coded block, the LIC parameters are applied to generate the corresponding prediction samples for the OBMC of the LIC coded block. Besides, to reduce the complexity, the OBMC is only applied to the top and left CU boundaries while being always disabled for the boundaries of the internal sub-blocks of the LIC coded block.

More details of OBMC can be found in JVET-AD2025 (Muhammed Coban, et. al., “Algorithm description of Enhanced Compression Model 9 (ECM 9)”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD2025).

### Multiple Downsampling Filters (MDF) for Cross-Component Modes

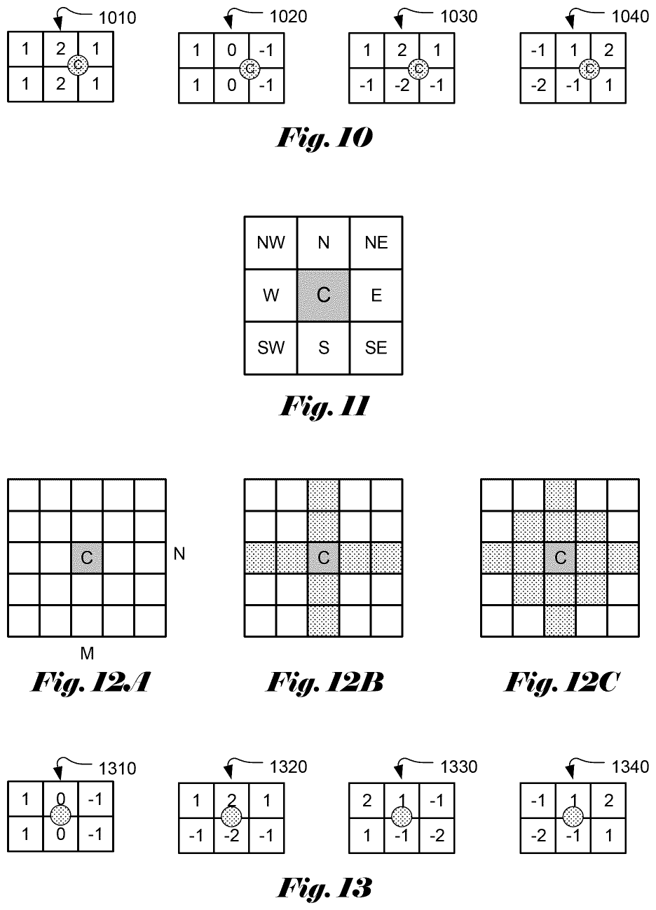

It is proposed to apply multiple downsampling filters to a group of reconstructed luma samples in a CCCM. The linear combination of these downsampled reconstructed samples is multiplied by derived filter coefficients to form the final chroma predictor. The horizontal or vertical location of the center luma sample may be also considered in the proposed model. The coefficients are derived by Gaussian elimination method as currently used by CCCM modes in ECM. The cross-component models shown below are tested as additional CCCM modes with a mode index signaled in the bitstream:

$$predChroma = c 0 * H ( C ) + c 1 * G 1 ( C ) + c 2 * G 2 ( C ) + c 3 * G 3 ( C ) + c 4 * P ( H ( C ) ) + c 5 * P ( G 1 ( C ) ) + c 6 * P ( G 2 ( C ) ) + c 7 * X + c 8 * Y + c 9 * B \qquad Model 1$$

$$predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * P ( H ( C ) ) + c 7 * P ( H ( W ) ) + c 8 * P ( H ( E ) ) + c 9 * X + c 10 * B \qquad Model 2$$

$$predChroma = c 0 * H ( C ) + c 1 * H ( NE ) + c 2 * H ( SW ) + c 3 * G 3 ( C ) + c 4 * G 3 ( NE ) + c 5 * G 3 ( SW ) + c 6 * P ( H ( C ) ) + c 7 * P ( H ( NE ) ) + c 8 * P ( H ( SW ) ) + c 9 * Y + c 10 * B \qquad Model 3$$

where H(⋅) 1010, G1(⋅) 1020, G2(⋅) 1030, and G3(⋅) 1040 are various downsampling filters as indicated in FIG. 10, C denotes the current chroma sample position, and N, S, W, E, NE, SW are the down-sampled luma positions around C as indicated in FIG. 11, ci are filter coefficients, P and B are nonlinear term and bias term, and X and Y are the horizontal and vertical locations of the centre luma sample with respect to the top-left coordinates of the block. It is noted that Model 1 is a 1×1 prediction shape using current chroma sample only while the other models are one-directional prediction models using 3 chroma samples.

The cross-component information is used to improve prediction accuracy of an inter block. To improve the prediction accuracy of the chroma component of the inter block, the luma information from the corresponding luma component of the current chroma block, and/or the chroma information from the current chroma block, and/or the chroma information from the previous coded chroma component are used.
The first scheme is that for a coding unit (under single tree splitting) including luma (Y) and chroma (Cb and/or Cr) components, the prediction for Cb and/or Cr is improved by applying the cross-component models to information (current reconstructed or predicted) from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by applying the cross-component models to information (current reconstructed or predicted) from Cb.

In the following, several embodiments related to the first scheme are proposed to use an inherited cross-component mode for the current chroma block with the following steps: Step (1) building a candidate list (modelList) for the current block where the candidate list includes cross-component models; Step (2) selecting one or more sets of model information in the list; and Step (3) using the model information (similar to intra chroma cross-component mode) to generate one or more hypotheses of prediction for the current chroma component (Cb or Cr) by applying and/or modifying the selected model information to the reconstructed or predicted samples for the corresponding luma component.

When the selected model information refers to traditional cross-component linear model(s), the proposed method is called as inter cross-component linear model (inter CCLM) mode. When the selected model information refers to convolutional cross-component model(s) (CCCM) derived by a regression-based method (e.g. CCCM), the proposed method is called as inter cross-component convolution model (inter CCCM) mode.

Moreover, in some embodiments, a self-derived (or re-derived) cross-component mode is proposed and can be added into the candidate list in Step (1). In some embodiments, the self-derived cross-component mode is not added into the list and a selection of using the proposed inherited mode and/or using the proposed self-derived mode is designed. In some embodiments, the selection of using the proposed inherited mode and/or using the proposed self-derived mode is determined following an explicit rule, an implicit rule, or both. More details are described in the section entitled “IV. Selection of Using the Proposed Inherited Mode and/or Using the Proposed Self-Derived Mode”.

In one embodiment, the proposed embodiments can also be used for the second scheme by using the previous coded chroma component (Cb) as the luma component in the first scheme.

### Storage and Inheritance of the Model

In another embodiment, when the current inter block uses the model parameters from the self-derived cross-component mode, the used model parameters can be saved and/or referenced by the following coding blocks. For an example of the self-derived cross-component being CCRM, all or any subset of the model parameters can be saved. In one embodiment, if the following coding block is intra, it is allowed to use the saved model parameters. If the following coding block is inter or any mode-type (e.g., IBC), it is allowed to use the saved model parameters. In another embodiment, if the following coding block and the current block have different mode-types (e.g., one being an inter block and one being not an inter block), it is not allowed to use the saved model parameters.

In another embodiment, when the current inter block uses the inherited cross-component mode, the used model parameters can be saved and/or referenced by the following coding blocks. For an example of the inherited CCCM, all or any subset of the model parameters can be saved. In one embodiment, if the following coding block is intra, it is allowed to use the saved model parameters. If the following coding block is inter or any mode-type (e.g. IBC), it is allowed to use the saved model parameters. In another embodiment, if the following coding block has different mode-type (e.g., not an inter block), it is not allowed to use the saved model parameters.

In another embodiment, when the current inter block uses any cross-component models (e.g. the inherited cross-component model, the self-derived cross-component model, cross-component model used in chroma fusion which means the chroma prediction is based on adding one or more hypotheses of cross-component prediction to one or more existing hypotheses of prediction of non-cross-component prediction, or any combination of the above), the used model parameters can be saved and/or referenced by the following coding blocks. For an example of the inherited CCCM, all or any subset of the model parameters can be saved. In one embodiment, if the following coding block is intra, it is allowed to use the saved model parameters. If the following coding block is inter or any mode-type (e.g. IBC), it is allowed to use the saved model parameters. In another embodiment, if the following coding block has a different mode-type (e.g., not an inter block), it is not allowed to use the saved model parameters.

### I. Building a Candidate List Including Cross-Component Models

In one embodiment, when building the merge-like candidate model list (modelList), one or more sets of the following candidate model information are included. For each candidate in the list, it refers to a candidate model information. The definition of the model information can be found in the section entitled: “V.1. Inheriting CCM Information”.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “spatial model information from spatial neighbour blocks” in the above candidate type list, a valid spatial neighbouring block(s) can be from one of spatial adjacent and non-adjacent neighbours (or any subset of the blocks in a neighbouring search region for the current block) which satisfies a pre-defined condition. For an example of non-adjacent neighbours, the pre-defined condition (e.g., valid/available checking) refers that the non-adjacent neighbour is in the available region of non-adjacent spatial candidates. For example, the pre-defined condition is that the neighbour is coded by a cross-component mode or combining with cross-component mode. The cross-component mode refers to modes such as CCLM, MMLM, CCCM, GLM, the mode with mode information inherited from a merge-like candidate list, MH CCLM, and/or any cross-component mode with syntax belonging cross-component branch (containing many cross-component modes) and not belonging to tradition intra prediction modes). Combining with cross-component mode refers to modes such as chroma fusion (or named LM assisted Angular/Planar Mode), inter CCLM, inter CCCM, and/or any traditional mode with syntax not belonging to cross-component branch, but using the cross-component information to generate the prediction. In another sub-embodiment, when checking the validation of a neighbouring coding block, a second-round valid checking is further used when the mentioned valid checking (e.g., neighbouring block not being cross-component mode or neighbouring block not using/combining cross-component mode), the motion vectors and/or block vectors of the neighbouring block can be used to find the cross-component models. Variations of how to use motion vector and/or block vectors to find the model can reference the description of “Temporal model information from collocated blocks” in the above candidate type list. If the model is found, the second-round valid checking for the neighbouring block is satisfied and the found models can be inserted in the list; otherwise, the neighbouring block is not valid for inserting. When scanning the spatial neighbouring blocks, a candidate is added into the list if the candidate is valid.

In another sub-embodiment of the candidate type being “Temporal model information from collocated blocks”, in the first case, the collocated block is from the block in the reference picture or the pre-defined collocated picture as inter mode by using the current block position and/or the current block motion, and/or in the second case, the collocated block is from the block in the reference picture or the pre-defined collocated picture as inter mode by using the current block position and/or the neighbouring block motion. In the first case, for example, when the current block is coded by inter prediction mode, the collocated block is referred by the motion information (including the motion vectors and the reference picture indicated by the reference index) of the current block. If the current block is a subblock motion mode (e.g., affine mode), each subblock in the current block has its own collocated temporal model information. Collocated temporal model information from all or any subset of collocated temporal information that are referred by the different subblock motions (of each subblock) are added into the list. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the temporal information from the reference picture is forbidden to be used. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the motion vector is scaled to refer the pre-defined collocated picture and the scaled motion vector is used to find the collocated block in the collocated picture to get the cross-component model in the collocated block. The scaling process is shown in the section of “Inheriting Temporal Neighbouring Model Parameters” and the section of “Temporal Candidates Derivation”. Some examples are described for the second case. For one example, the temporal model information can be from the collocated block referred by the motion information of the neighbouring blocks for the current block. Similar to the first case, the forbidden method or the scaling method can be used in the second case. If the proposed methods are applied to an IBC block or any mode using block vectors (in the first case, the current block being IBC; in the second case, the neighbouring block being IBC), block vector information is used as motion vector where the block vector information is determined by signalling and/or template matching in a pre-defined searching range like intraTMP and/or any implicit or explicit pre-defined rules. More details can be found in the section of “Inheriting Temporal Neighbouring Model Parameters”.

In another sub-embodiment of the candidate type being “History-based model information”, a history-based table (the FIFO table) is built and stores the model information from the previous coded blocks. The table can be reset as the beginning and/or the end of a CTU, slice, picture, tile, and/or sequence. One or more history-based candidates can be added into the candidate list by the order from the head to tail of the table or from the tail to head of the table.

In another sub-embodiment of the candidate type being “Pairwise average model information”, the model information of this candidate is derived based on the model information from more than one of the previous candidates in the list. For example, it can average and/or modify the model parameters of more than one candidate as the to-be-applied model parameters. For another example, it can combine more than one prediction as the final prediction, where each of more than one prediction is generated by applying one of models in the candidate list.

In another sub-embodiment, the default model information is added if the list is not full after inserting all pre-defined candidates. For example, the default model can be CCLM models. The default alpha (or named as a, a, or scaling parameters) are selected from {0, ⅛, −⅛, 2/8, − 2/8, ⅜, −⅜, . . . }, and the beta (or named as P, b, or offset parameter) is based on the selected default alpha, average neighbouring reconstructed luma sample value, and average neighbouring reconstructed chroma (Cb/Cr) sample value.

In another sub-embodiment, the candidate list for the inter chroma block is unified with the candidate list for intra chroma block and/or can be generated based on the candidate list for intra chroma block by further including inter-specific candidates (e.g., temporal model information referred by the current motion) and/or can be any subset of the candidate list for intra chroma block. For example, some specific cross-component modes are not allowed to be inserted in the list. The disallowed cross-component modes can refer to GLM modes, any subset of GLM modes, MDF modes, any subset of MDF modes, any combination of the above-mentioned modes, or any subset of the cross-component modes for intra. For another example, only some specific cross-component modes are allowed to be inserted into the list. The allowed cross-component modes can be the modes which use the non-down-sampling (or non-sub-sampling) luma reference samples, such as non-sub-sampling CCCM and/or CCRM. The allowed cross-component modes can be CCCM, CCRM, CCLM, MMLM, any combination of the above-mentioned modes, or any subset of the cross-component modes for intra. Details of the candidate list can be found in the sections entitled: “V. Details of the Cross-Component Mode (Including Model Information) in the Candidate List” and “VI. Constructing a Candidate List”.

In another embodiment, when building modelList, one or more self-derived cross-component candidates are included. The self-derived cross-component candidates are described in the section entitled “Self-derived Cross-Component Model”. In another sub-embodiment, the self-derived cross-component candidates are added only when the list does not contain enough inherited candidates. For example, the self-derived candidates are added before the default candidates or treated as the default candidates. In another sub-embodiment, the self-derived cross-component candidates are added in any pre-defined position in the modelList. For example, the position is after the spatial adjacent candidates. For another example, the position is after the spatial non-adjacent candidates. For another example, the position is after all or any subset of temporal candidates.

In another embodiment, more details/variations of construction of the modelList can be found in the section entitled “VI. Constructing a Candidate List”. For example, the order of inserting a candidate into the list follows the description in the section of “Order of inserting a candidate into the list”.

After building the list, in one embodiment, the list is reordered as the methods defined in the section “Reordering the candidates in the list.”

### II. Signalling for Model Information Control

In this section, the term “inter CCLM” refers to “inter CCLM or inter CCCM”.

When not applying the proposed inter CCLM (or inter CCCM), the prediction of the current block is from the original inter prediction.

In another embodiment, the choice between applying inter CCLM or not applying inter CCLM depends on signalling.

In one sub-embodiment, the signalling refers to a coded TU/TB/CU/CB level flag. The flag may or may not depend on context to code. Take the TU/TB flag as an example, the flag is signalled only if the TU/TB's luma Cbf is non-zero and the enabling flag for the inter mode is true. Take the CU/CB flag as an example, the flag is signalled only if the CU/CB's luma Cbf is non-zero and the enabling flag for the inter mode is true. The enabling flag for the inter mode means the CU's predMode is MODE_INTER when the proposed inter CCLM (or inter CCCM) is supported for all inter modes. When the proposed inter CCLM (or inter CCCM) is supported for IBC. The enabling flag for IBC is checked first and the signalling for inter CCLM (or inter CCCM) is coded/decoded in response to the CU's predMode being MODE_IBC. When the proposed inter CCLM (or inter CCCM) is supported only for CIIP, the enabling flag for CIIP is checked first and the signalling for inter CCLM (or inter CCCM) is coded/decoded in response to the CIIP flag being true. When the proposed inter CCLM (or inter CCCM) is supported only for merge, the merge flag is checked first and the signalling for inter CCLM (or inter CCCM) is coded/decoded in response to the merge flag being true. When the proposed inter CCLM (or inter CCCM) is supported only for AMVP, the merge flag is checked first and the signalling for inter CCLM (or inter CCCM) is coded/decoded in response to the merge flag being false. The proposed inter CCLM (or inter CCCM) can be supported only for any pre-defined subset of merge modes, any pre-defined subset of inter modes, or any pre-defined subset of non-intra modes.

In another sub-embodiment, when the signalling indicates to apply inter CCLM (or inter CCCM), additional signalling is used to select one or more models from total candidates. The candidate index is referred as modelIdx in this disclosure. If the modelList containing total candidates (e.g., candidates as described in section entitled “Building a Candidate List Including Cross-Component Models”, CCLM_LT, CCLM_L, CCLM_T, MMLM_LT, MMLM_L, MMLM_T), or any subset of candidates are reordered by the methods in the section “Reordering the candidates in the list”, the additional signalling specifies the candidate index in the reordered list. For example, if one LM mode is selected, the LM prediction is generated by the selected one LM. For another example, if more than one LM modes are selected the LM prediction is generated by blending hypotheses of prediction from multiple LM modes.

In another sub-embodiment, the additional signalled is not required and the one or more models are selected according to an implicit rule. For example, the one or more selected models are implicitly determined or the one or more models used for the current block are determined without signalling modelIdx. For example, the first candidate in the list is used. If the list is reordered by the template cost, then, the first candidate is the candidate with the smallest template cost.

In another embodiment, whether to use inter CCLM (or inter CCCM) and/or the selection of cross-component modes are separate for list0 and list1 of a bi-prediction block. For an example of the selection of cross-component modes for list0 and list1 being separate, for each listx (x=0 or 1) of the bi-prediction block, a selection of cross-component modes (e.g. an explicit index or an implicit rule) is used and the selection of cross-component modes can be different for list0 and list1.

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (i.e., neither intra nor inter).

In another embodiment, the one or more LM modes (i.e., cross-component modes) which will be used to generate the one or more hypotheses of prediction for LM assisted Angular/Planar Mode/inter CCLM/inter CCCM/MH CCLM are selected from a pre-defined merging candidate list (i.e., modelList). One modelIdx is signalled to select a candidate from the candidate list (modelList) and the selected candidate is used for the current block. The modelList contains one or more candidates where each candidate refers to a model (or cross-component mode) information. If only one candidate is in the list (i.e., the size of the list being 1), the modelIdx is not signalled and/or can be inferred as 0 or a default value. In one embodiment, the modelIdx is implicitly determined or the one or more models used for the current block are determined without signalling modelIdx. For example, the first candidate in the list is used. If the list is reordered by the template cost, the first candidate is the candidate with the smallest template cost. For another example, the used candidate/model is implicitly selected from the list by using a pre-defined rule depending on the coding information of the block for the to-be-used candidate.

In one embodiment, when building modelList, one or more predefined candidates are added. The pre-defined candidates can include any subset/extension of the following candidates and/or more candidates in the section entitled “V. Details of the Cross-Component Mode (including Model Information) in the Candidate List”.
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g., IBC merge or IBC AMVP or any IBC mode under IBC syntax). The term “inter” in this invention can be changed to IBC. That is, for chroma components, the block vector prediction can be combined or replaced with cross-component prediction.

### III. Using the Model Information to Generate One or More Hypotheses of Prediction for the Current Chroma Component

### III.1. Concept

In one embodiment, prediction or reconstruction-based model is used to generate one hypothesis of prediction for the current chroma component.

In one sub-embodiment of a prediction based linear model, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampled with the downsampling filters, which may be fixed at one-predefined filter or selected among some candidate filters.

In another sub-embodiment of a reconstruction based linear model, the derived model parameters are applied to the reconstructed samples for the first component (Y) to get the predicted samples for the second or third component.

$$P ( i , j ) = a \cdot {reco}_{L}^{′} ( i , j ) + b$$

The reconstructed samples for the first component are down-sampled with the downsampling filters, which may be fixed at one-predefined filter or selected among some candidate filters.

Prediction or reconstruction based convolution model is similar to the proposed methods for the prediction or reconstruction based linear model. The main difference is that the model coefficient pattern follows CCCM (not CCLM) and the luma samples may or may not be down-sampled first.

In another embodiment, multiple hypotheses (MH) of cross-component predictions are blended or multiple models are used to generate a hypothesis of prediction for the current block. Multiple-hypothesis CCLM is proposed to blend the predictions from multiple CCLM methods. The term “CCLM methods” can refer all the cross-component modes. The to-be-blended CCLM methods can be from (but are not limited to) the above mentioned CCLM methods (e.g., CCLM, MMLM, CCCM, GLM, CCRM, . . . ) and/or models defined in section entitled as “V. Details of the Cross-Component Mode (Including Model Information) in the Candidate List”. A weighting scheme is used for blending.

In one sub-embodiment, the weighting scheme depends on the template costs of multiple cross-component modes (i.e., two or more cross-component modes) selected from the list. Similar to TIMD, multiple cross-component modes with smaller template costs are selected from the list and the predictions from the selected cross-component modes are combined with template-based weighting. The template-based weighting uses a higher weight for the prediction generated by the mode with a smaller template cost. When calculating weights, a lookup table is used to avoid calculation of floating point. In addition, the enabling condition of combining can be used to determine whether to combine. The combining is only performed if the enabling condition is satisfied. For example, as TIMD, using “costMode2<2*costMode1 or (costMode2−costMode1)<costMode1)” as the enabling condition. When the enabling condition of combining is not satisfied, only one of the cross-component mode is used to form the cross-component prediction. The one used to form the cross-component prediction can be the cross-component mode with the smallest template cost in the list.

In another sub-embodiment, multiple cross-component modes are selected from different template regions respectively. The weighting for blending multiple cross-component modes is position-dependent and each sample in the current block derives its own weight (since the position of each sample is different) depending on the distance between the template regions and the current sample. For example, one cross-component mode is suggested from the top template and another cross-component mode is suggested from the left template. For the current sample, the hypothesis of prediction from the candidate suggested by the top template has a higher weight if the current sample is near the top template. For the current sample, the hypothesis of prediction from the candidate suggested by the left template has a higher weight if the current sample is near the left template. An example of the weighting is shown here where (x, y) is the position of the current sample within the current block with x is from 0 to (block width−1) and y is from 0 to (block height−1). When blending the hypotheses to predict the current sample positioned at (x, y), the weight of the hypothesis suggested from the top template is denoted as w_{Top}, and the weight of the hypothesis suggested from the left template is denoted as w_{Left}.

$${w}_{Top} ( x , y ) + {w}_{Left} ( x , y ) = 64$$

$${w}_{Top} ( x , y ) = 32 + \frac{32 x}{width} - \frac{32 y}{height} .$$

If the mode suggested from either left or top template corresponds to a large template cost, the position-dependent weighting is further adjusted to reduce the weighting for the mode with a very large template cost.

In another sub-embodiment, the MH of cross-component predictions is formed as an intra prediction. If the combining for intra will get combined predictor values exceeding the sample range (i.e., if combining the multi-hypotheses of cross-component predictions results in a combined predictor for intra prediction with value exceeding the sample range), the combined predictor for intra is first clipped into the sample range (e.g., 0 to 1023 if the precision is 10 bit) to form the intra prediction. If the weighting scheme follows TIMD, the circuit for TIMD can be reused here. Then the intra prediction may further be combined with the inter prediction. In another sub-embodiment, if the combining for intra (e.g., MH of cross-component predictions) will get the combined predictor values exceeding the sample range, the combined predictor for intra is not clipped into the sample range (e.g., 0 to 1023 if the precision is 10 bit). The intra prediction may further be combined with the inter prediction and the clipping is applied after combining intra and inter (i.e., combining intra prediction and inter prediction). In this method, it is not required to first perform clipping on the combining for intra and can just perform clipping on the combination of intra and inter. More variations of using multiple hypotheses of prediction from cross-component models are defined in the section entitled “Inheriting Multiple Cross-Component Models”.

### III.2. CCLM for Inter Block

The term “CCLM for inter block” can also be named as “inter CCLM” and “CCLM” can be extended to any LM mode (or any cross-component mode) or replaced with any LM mode (or any cross-component mode). When convolutional cross-component models derived by a regression-based method is used, CCLM for inter block can also be named as inter CCCM.

In one embodiment, for chroma components, in addition to original inter prediction (generated by motion compensation which can be uni-prediction and/or bi-prediction, multiple hypotheses of prediction from multiple motion candidates which may refer to one or more merge candidates, one or more AMVP candidates, any combination of above, or which can be only uni-prediction), one or more hypotheses of prediction (generated by CCLM and/or any other LM modes) are used to generate the current prediction.

In one sub-embodiment, the current prediction is the weighted sum of inter prediction and CCLM prediction.

In another embodiment, the inter prediction can be generated by any inter mode mentioned above. For example, the inter mode can be regular merge mode. For another example, the inter mode can be CIIP mode. For another example, the inter mode can be GPM or any GPM variations (e.g., GPM intra referring one prediction unit using intra prediction).

In another embodiment, inter CCLM is supported only when one or more of the pre-defined inter modes are used for the current block, or inter CCLM is supported when any one (or more than one) of the enabling flag(s) of the pre-defined inter mode is(are) indicated as enabled. The meaning of supporting inter CCLM is that the prediction of the current block can be chosen between applying inter CCLM or not applying inter CCLM.

When applying inter CCLM, the prediction of the current block is generated by:
In one sub-embodiment: blending one or more hypotheses of prediction: (generated by CCLM and/or any other LM modes) with original inter prediction
   Blending the chroma prediction for existing inter mode and the prediction from LM

$$Blending : Predfinal = ( wInter * PredInter + wLM * PredLM + 2 ) ≫ 2$$

rule: wInter and wLM, for example,
   If both top and left are intra (or any cross-component mode), (wInter, wLM)=(1, 3)
   Otherwise, if one of top and left is intra, (wInter, wLM)=(2, 2)
   Otherwise, (wInter, wLM)=(3, 1)
   For another example, the weighting follows CIIP weighting rules.
For example, predInter=inter prediction after OBMC (if OBMC is used)
For another example, predInter=inter prediction before OBMC (OBMC can be applied after blending)
In another sub-embodiment: replacing original inter prediction with one or more hypotheses of prediction (generated by CCLM and/or any other cross-component modes)
In another sub-embodiment, for the following coding blocks, if the neighbouring block is coded by inter CCLM (or inter CCCM) or any mode with chroma prediction using cross-component modes or any mode with chroma prediction using cross-component modes and motion-compensated predictors, the OBMC of the following coding blocks considers to use the cross-component modes to generate one or more hypotheses of prediction for that following coding blocks to adjust the predictors of that following coding blocks.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

IV. Selection of Using the Proposed Inherited Mode and/or Using the Proposed Self-Derived Mode

In one embodiment, a flag can be signalled to indicate/select if the re-derived model is used. If the flag is 0, the cross-component model used to encode the neighbour merge candidate is inherited. If the flag is 1, the re-derived method is used.

In another embodiment, an implicit rule (not using the additional flag) is used to determine whether to use the re-derived model.

In another embodiment, if no model can be inherited during building the modelList, or the spatial adjacent/non-adjacent candidates, history candidates, temporal candidates, or all or any subset (e.g., before default candidates) of mentioned candidates in this invention are not available, use the re-derived model.

In another embodiment, when the proposed inherited method is used. The candidate with the smallest cost (e.g., the first candidate in the modelList) is implicitly selected to generate the cross-component prediction. For another example, an index is signalled to select one or more candidates from the modelList. More details can be found in Section II.

### V. Details of the Cross-Component Mode (Including Model Information) in the Candidate List

### V.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include, but not limited to, prediction mode (e.g., CCLM, MMLM, CCCM, 2-parameter GLM, 3-parameter GLM (GLM model with luma term), model index for indicating which model shape is used in the convolutional model, classification threshold for multi-model, information to indicate that non-downsampled samples are used in the convolutional model, down-sampling filter flag (whether to do down-sampling), down-sampling filtering index when multiple down-sampling filters are used, number of neighbouring lines used to derive the model, types of templates used to derive model, post-filtering flag, and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in the centre position, two gradient terms for the horizontal direction and vertical direction, two location terms X and Y for the relative horizontal location and relative vertical location, one non-linear term and one bias term. A prediction mode can be stored in the CCM information to indicate that the inherited model is a GL-CCCM model.

### V.2. Inheriting Temporal Neighbouring Model Parameters

In one embodiment, if the current slice/picture is a non-intra slice/picture, the inherited model parameters can be from the block in the previous coded slices/pictures.

In one embodiment, the current block position is at (x, y) and the block size is w×h. The inherited model parameters can be from the block at some pre-defined positions of the previous coded slices/picture.

In one sub-embodiment, the pre-defined positions can be (x+Δx, y+Δy) or (x_{mid}+Δx, y_{mid}+Δy), where (x_{mid}, y_{mid})=(x+w/2, y+h/2). The two value sets αₓ and α_{y} are defined as:

$${α}_{x} = \{ {α}_{x 1} , {α}_{x 2} , {α}_{x 3} , ... , {α}_{xn} \} , {α}_{xi} < {α}_{xj} if i < j ,$$

$${α}_{y} = \{ {α}_{y 1} , {α}_{y 2} , {α}_{y 3} , ... , {α}_{yn} \} , {α}_{yi} < {α}_{yj} if i < j .$$

All values in ax and ay are positive numbers.

For example, (Δx, Δy) can be (±αₓᵢ×w, ±α_{yi}×h), (±αₓᵢ×w, 0), (0, ±α_{yi}×h).

For example, αₓ=α_{y}. For example, αₓ=α_{y}={1, 2, 3, 4, 5}.

For example, αₓ≠α_{y}. For example, α_x={½, 1, 3/2, 2, 5/2} and α_{y}={1, 2, 3, 4, 5}.

In one sub-embodiment, the pre-defined positions (x′, y′) are inside the corresponding area of the current encoding block, i.e., x≤x′<x+w and y≤y′<y+h. The pre-defined positions can be (x, y), (x+w−1, y), (x, y+h−1),(x+w−1, y+h−1), (x+w/2, y+h/2), (x, y+h/2), (x+w/2, y).

In one sub-embodiment, the pre-defined positions (x′, y′) are outside of the corresponding area of the current encoding block, i.e., x′<x+ or x′≥x+w, and y′<y or y′≥y+h. The pre-defined positions can be (x−1, y), (x, y−1), (x−1, y−1), (x+w, y),(x+w−1, y−1), (x+w, y−1),(x, y+h),(x−1, y+h−1),(x−1, y+h),(x+w, y+h−1),(x+w−1, y+h),(x+w, y+h).

In one embodiment, the models from the positions closer to (x, y) are added into the final merge candidate list first.

The previous coded picture, from which the inherited parameter model is obtained, is referred to as the collocated picture hereafter.

In one embodiment, the previous coded picture where the inherited parameter model is from (i.e., the collocated picture), is one of the pictures in the reference lists.

In one embodiment, the collocated picture is signalled in the picture/slice header. The reference list and the reference index are signalled in the picture/slice header. For example, the collocated picture is selected as L0[0]. For another example, the collocated picture is selected as L1[0].

In one embodiment, the positions in the previous coded slices/pictures, where the inherited parameter model is from, is determined by the motion vector of a neighbouring block. Let Δx and Δy be the horizontal and vertical displacement determined based on the selected motion vector of the neighbouring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

V.3. Inheriting from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by a chroma intra fusion mode, the model parameters for obtaining the CCP coded intra prediction are inherited (or called derived) and further refined.

In one embodiment, in addition to inheriting and refining the CCP model parameters, the fusion weight and the coding mode of non-CCP coded intra prediction are also inherited (or called derived). That is, the chroma intra fusion mode is inherited.

### V.4. Inheriting Multiple Cross-Component Models

The final prediction of the current block can be the combination of prediction of multiple cross-component models, or fusion of the predictions of the selected cross-component models with the prediction by non-cross-component coding tools (e.g., intra angular prediction modes, intra planar/DC modes, or inter prediction modes). In one embodiment, if the current candidate list size is N, it can select k candidates from the total N candidates (where k≤N). Then, k predictions are respectively generated by applying the cross-component model of the selected k candidates using the corresponding luma reconstructed samples. The final prediction of the current block is the combination results of these k predictions. For example, if two candidate predictions (denoted as p_{cand1} and p_{cand2}) are combined, the final prediction at (x, y) position of the current block is p_{final}(x, y)=(1−α)×p_{cand1}(x, y)+α×p_{cand2}(x, y), where a is a weighting factor. Besides, the weighting factor α can be predefined or implicitly derived according to neighbouring template cost (i.e., model error). For example, by using the template cost defined in the section entitled “Reordering the Candidates in the List”, the corresponding template cost of two candidates are e^{cand1} and e^{cand2}, then α is e^{cand1}/(e^{cand1}+e^{cand2}). In another embodiment, if two candidate models are combined, the selected models are from the first two candidates in the list. In still another embodiment, if i candidate models are combined, the selected models are from the first i candidates in the list.

In another embodiment, two cross-component models are combined into one final model by weighted-averaging the corresponding model parameters. One of the two cross-component models is from above the spatial neighbouring candidate and another one is from the left spatial neighbouring candidate. The above spatial neighbouring candidate is the neighbouring candidate that has the vertical position less than or equal to the top block boundary position of the current block. The left spatial neighbouring candidate is the neighbouring candidate that has the horizontal position less than or equal to the left block boundary position of the current block. The weighting factor α is determined according to the horizontal and vertical spatial positions inside the current block. For example, if two candidate predictions (denoted as p_{above} and p_{left}) are combined, the final prediction at (x, y) position of the current block is p_{final}(x, y)=(1−α)×p_{above}(x, y)+α×p_{left}(x, y), where α=y/(x+y). In another embodiment, the above spatial neighbouring candidate is the first candidate in the list that has the vertical position less than or equal to the top block boundary position of the current block. The left spatial neighbouring candidate is the first candidate in the list that has the horizontal position less than or equal to the left block boundary position of the current block.

In another embodiment, it can combine cross-component model candidates with the prediction of non-cross-component coding tools. For example, one cross-component model candidate is selected from the candidate list, and its prediction is denoted as p_{ccm}. Another prediction can be from chroma DM, chroma DIMD, or intra angular mode, and denoted as p_{non-ccm}. The final prediction at (x, y) position of the current block is p_{final}(x, y)=(1−α)×p_{ccm}(x, y)+α×p_{non-ccm}(x, y), where a is the weighting factor which can be predefined or implicitly derived according to neighbouring template cost. For still the same example, the prediction by non-cross-component coding tool can be predefined or signalled. The prediction by non-cross-component coding tool is chroma DM or chroma DIMD. For another example, prediction by non-cross-component coding tool is signalled, but the index of cross-component model candidate is predefined or determined by the coding modes of neighbouring blocks. For still the same example, if at least one of neighbouring spatial blocks is coded with CCCM mode, the first candidate has CCCM model parameters is selected. If at least one of neighbouring spatial blocks is coded with GLM mode, the first candidate that has GLM pattern parameters is selected. Similarly, if at least one of neighbouring spatial blocks is coded with MMLM mode, the first candidate that has MMLM parameters is selected.

In another embodiment, it can combine the prediction of cross-component model candidates with the prediction of the current cross-component model. For example, one cross-component model candidate is selected from the list, and its prediction is denoted as p_{ccm}. Another prediction can be from the cross-component prediction mode whose model is derived based on the current neighbouring reconstructed samples and is denoted as p_{curr-ccm}. The final prediction at (x, y) position of the current block is p_{final}(x, y)=(1−α)×p_{ccm}(x, y)+α×p_{curr-ccm}(x, y), where a is the weighting factor which can be predefined or implicitly derived according to neighbouring template cost. For still the same example, the prediction by the current cross-component model can be predefined or signalled. The prediction by non-cross-component coding tool can be CCCM_LT, LM_LT (single model LM using both top and left neighbouring samples to derive model), or MMLM_LA (multi-model LM using both the top and left neighbouring samples to derive model). In one embodiment, the selected cross-component model candidate is the first candidate in the list.

### VI. Constructing a Candidate List

### VI.1. Reordering the Candidates in the List

The candidates in the list can be reordered to reduce the syntax overhead when signalling the selected candidate index or to bypass the syntax for signalling the selected candidate index by using implicit rule to select the one or more candidates.

In one embodiment, the reordering rules can depend on the coding information of neighbouring blocks or the model error. For example, if neighbouring above or left blocks are coded by MMLM, the MMLM candidates in the list can be moved to the head of the current list.

In one embodiment, the reordering rule is based on the model error by applying the candidate model to the neighbouring templates of the current block, and then compare the error with the reconstructed samples of the neighbouring template.

In another embodiment, the costs of some specific cross-component modes are further adjusted by increasing the costs or decreasing the costs. In one sub-embodiment, the specific cross-component modes refer to GLM modes, any subset of GLM modes, MDF modes, any subset of MDF modes, any combination of the above-mentioned modes, or any subset of the cross-component modes for intra. For those specific cross-component modes, the costs are increased by adding a positive offset or scaling by a factor larger than 1. In an extreme case, the costs of those specific cross-component modes are set to maximum values. That is, those specific cross-component modes may not have an opportunity to be used if the list contains other modes. In another sub-embodiment, the specific cross-component modes refer to the modes which use the non-down-sampling (or non-sub-sampling) luma reference samples, such as non-sub-sampling CCCM and/or CCRM, CCLM and/or MMLM, any combination of the above-mentioned modes, or any subset of the cross-component modes for intra. For those specific cross-component modes, the costs are decreased by subtracting a positive offset or scaling by a factor smaller than 1. In an extreme case, the costs of those specific cross-component modes are set to minimum values. That is, those specific cross-component modes may have a high possibility to be used. The reordering of the list is performed on the adjusted costs.

### VII. Self-Derived Cross-Component Model

In one embodiment, an example of the self-derived cross-component model is CCRM. When doing the self-derivation, the model (filtering shape/pattern, parameter terms) is unified with the cross-component models in regular intra modes. For example, CCRM model can be unified with any pre-defined existing intra cross-component model (e.g. CCCM using non-downsampled luma samples, GLM, MMLM) and/or the self-derivation only means the input of deriving model parameters is from the current chroma and collocated luma samples (for example, motion compensation results if the current block is inter).

In another embodiment, the self-derived cross-component candidate refers to one or more models and the models are used to generate the cross-component prediction of the current block as follows. The cross-component prediction (used for generating target predicted samples) of the current bock is formed by combining one or more proposed source terms and the models (referring to a proposed weighting setting). As shown in equation (3), pred(i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (3) is just an example and our proposed mechanism can use any subset or extension of sourceTermSet0, sourceTermSet1, and biasTermSet. Each sample or any subset of samples in the current block gets its target (predicted) sample according to the equation (3). In the following, the content of sourceTermSet0 is described in Section VII.1, the content of sourceTermSet1 is described in Section VII.2, the content of biasTerm is described in Section VII.3, and the predictor derivation using the proposed source terms and the proposed weighting setting is described in Section VII.4. Several examples with our proposed mechanism are shown in Section VII.4.

$$pred ( i , j ) = ( sourceTermSet 0 ( i , j ) + sourceTermSet 1 ( i , j ) + … + biasTerm ) with the proposed weighting setting where ( i , j ) is a sample position in the current block . \qquad ( 3 )$$

VII.1. Content of sourceTermSet0(i, j)

SourceTermSet0(i, j) includes one or more luma source terms denoted as sourceTerm00, sourceTerm01, . . . , and/or sourceTerm0n−1. The value of n means the number of taps for the source term set.

In one embodiment, the source terms can be linear terms and/or non-linear terms, only linear terms, and/or only non-linear terms.

In another embodiment, n is a pre-defined value, such as 1, 2, . . . or any positive integer. For example, the pre-defined value is fixed in the standard.

In another embodiment, n is determined by coding information of the current block and/or sample position (i, j). For example, when the current block is coded by a specific coding tool, n can be fixed at a pre-defined value for that specific coding tool.

In another embodiment, the pattern of the n taps refers to a pattern defined as any subset of a window region M×N around/including the position (iL, jL) as shown in FIG. 12A. If the target sample is luma, (iL,jL) is (i, j). If the target sample is chroma (e.g., Cb or Cr), (iL, jL) is the collocated luma position from (i, j).

For one example, only the centre (iL,jL) of the window is used as shown in FIG. 12A.

For another example of the pattern being 5×5 cross including or not excluding (iL,jL) as shown in FIG. 12B. For yet another example of the pattern being 5×5 diamond as shown in FIG. 12C.

For a source term in the source term set, the following embodiments are used to determine generation of the source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples. If the target sample (i, j) belongs to chroma and gradient information of the collocated luma sample (as the centre circle) is calculated with any one of the following Sobel filters (1310-1340) in FIG. 13 or any pre-defined filter. Each value around the centre circle is multiplied with the corresponding predicted/reconstructed samples in the collocated luma block and then added with each other to form the gradient information for the source term of the target sample (i, j).

In another sub-embodiment, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the source term may further include location information. For example, if the target sample refers to luma, the horizontal location (i) of (i, j) is used in a source term and the vertical location (j) of (i, j) is used in a source term; otherwise, the horizontal location of the collocated luma block from the sample (i, j) is used in a source term and the vertical location of the collocated luma block from the sample (i, j) is used in a source term.

In another embodiment, the source term may further include location information. For example, if the target sample refers to chroma, the horizontal location of the collocated luma from the sample (i, j) is used in a source term, and the vertical location of the collocated luma from the sample (i, j) is used in a source term.

VII.2. Content of sourceTermSet1(i, j)

SourceTermSet1(i, j) includes one or more chroma (Cb or Cr) source terms denoted as sourceTerm00, sourceTerm01, . . . , and/or sourceTerm0m−1. The value of m means the number of taps for the source term set.

In one embodiment, the source terms can be linear terms and/or non-linear terms, only linear terms, and/or only non-linear terms.

In another embodiment, m is a pre-defined value such as 1, 2, . . . or any positive integer. For example, the pre-defined value is fixed in the standard.

In another embodiment, m is determined according to coding information of the current block and/or sample position (i, j). For example, when the current block is coded by a specific coding tool, m is fixed at a pre-defined value for that specific tool.

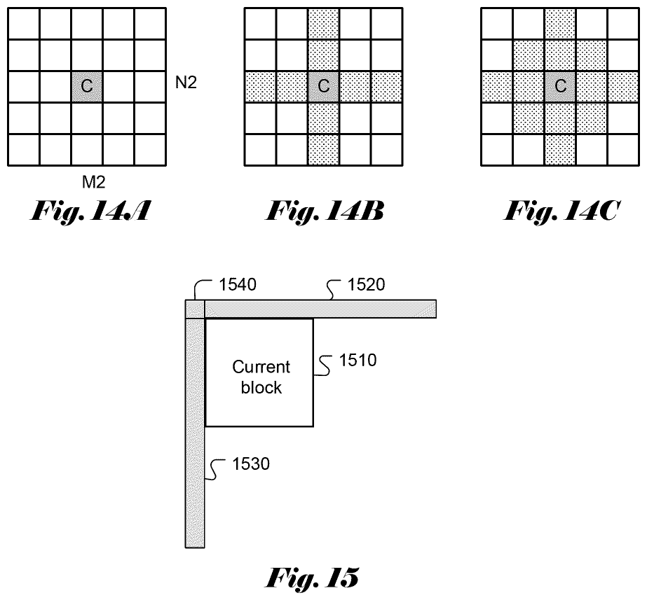

In another embodiment, the pattern of the m taps refers to a pattern defined as any subset of an M2×N2 window region around/including the position (iC, jC) as shown in FIG. 14A. If the target sample is chroma (Cb or Cr), (iC,jC) is (i, j). If the target sample is luma, (iC, jC) is the collocated chroma position from (i, j).

For one example, only the centre (iC,jC) of the window is used as shown in FIG. 14A.

For another example of the pattern being 5×5 cross: (including or not excluding (iC,jC)) as shown in FIG. 14B. For yet another example of the pattern being 5×5 diamond as shown in FIG. 14C.

For a source term in the source term set, the following embodiments are used to determine generation of the source content.

In one embodiment, the source content is based on a predicted sample generated by a prediction mode and/or a reconstructed sample generated based on the predicted sample based on a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples. If the target sample (i, j) belongs to luma, gradient information of the collocated chroma sample is calculated with any one of the Sobel filters or any pre-defined filter.

In another sub-embodiment, if the target sample belongs to a chroma sample, the predicted sample and/or the reconstructed sample is located within the current block. The predicted sample and/or the reconstructed sample is treated as an initial sample and used as the source content to generate the target sample.

In another embodiment, the source term may further include location information. For example, if the target sample refers to chroma, the horizontal location (i) of (i, j) is used in a source term and the vertical location (j) of (i, j) is used in a source term.

VII.3. Content of biasTerm

Bias term is a pre-defined value. In one embodiment, the bias term is a midValue according to bitDepth specified in the standard. For example, the bias term is set as (1<<(bitDepth−1)). In another embodiment, the bias term is the same for each sample in the current block. That is, the bias term is independent of the position (i, j).

### VII.4. Predictor Derivation for Sample (i, j)

### VII.4.1. Proposed Weighting Setting

The proposed weighting setting is to estimate the relationship (e.g. minimizing the distortion) between “the predicted and/or reconstructed samples on the reference region of the current (chroma) block” and “the predicted and/or reconstructed samples on the reference region of the corresponding luma block” by a pre-defined regression method, and to generate a weighting (referring to model parameters) according to the regression method. The weighting derived is then applied on the source terms to get the target (predicted) samples in the current block. In one embodiment, the pre-defined regression method can be linear minimum mean square error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

In one embodiment, the reference region of the current block is the spatial neighbouring region of the current block 1510 as shown in FIG. 15. The spatial neighbouring region of the current block includes above reference region 1520, left reference region 1530, above-left reference region 1540, and/or any subset of the above. The size of the above reference region is A_{w}×A_{H}, the size of the left reference region is L_{w}×L_{H}, and the size of the above-left reference is AL_{W}×AL_{H}, where
A_{w}=block width of the current block (W), k*W, W+block height of the current block (H), any pre-defined value, or any adaptive value depending on the block position, block width, block height, and/or block area of the current block.
A_{H} or AL_{H}=H, any pre-defined value (1, 2, 4, . . . ), or any adaptive value depending on the block position, block width, block height, and/or block area of the current block.
L_{W} or AL_{W}=W, any pre-defined value (1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

The reference region of the corresponding luma block is the spatial neighbouring region of the corresponding luma block.

In another embodiment, the reference region of the current block is the vector-collocated region of the current block and the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results obtained by using the motion information (e.g. block vectors and current picture) of the current block, and the vector-collocated region of the corresponding luma block refers to the motion compensated results obtained by using the motion information (e.g. block vectors and current picture) of the corresponding luma block.

In another embodiment, the above-proposed two kinds of the reference region of the current block can be used together. For example, generally, samples in the vector-collocated region of the current block are used as input samples during deriving model parameters; however, for a smaller block, samples in the spatial neighbouring reference region are used as additional input samples when deriving model parameters.

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of using the convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods of cross-component prediction by blending multiple hypothesis of cross-component prediction models can be implemented in encoders and/or decoders. For example, any of the proposed methods can be implemented in an inter, intra, prediction, IBC, transform, quantization module or a combination of them at an encoder side, and/or an inter, intra/prediction, IBC, transform, quantization module or a combination of them at a decoder side. Alternatively, any of the proposed methods can be implemented as a circuit coupled to the inter, intra, prediction, transform, quantization module or a combination of them at the encoder and/or the inter, intra, prediction, IBC, transform, quantization module of the decoder, so as to provide the information needed by the inter/intra/prediction/IBC/transform/quantization module.

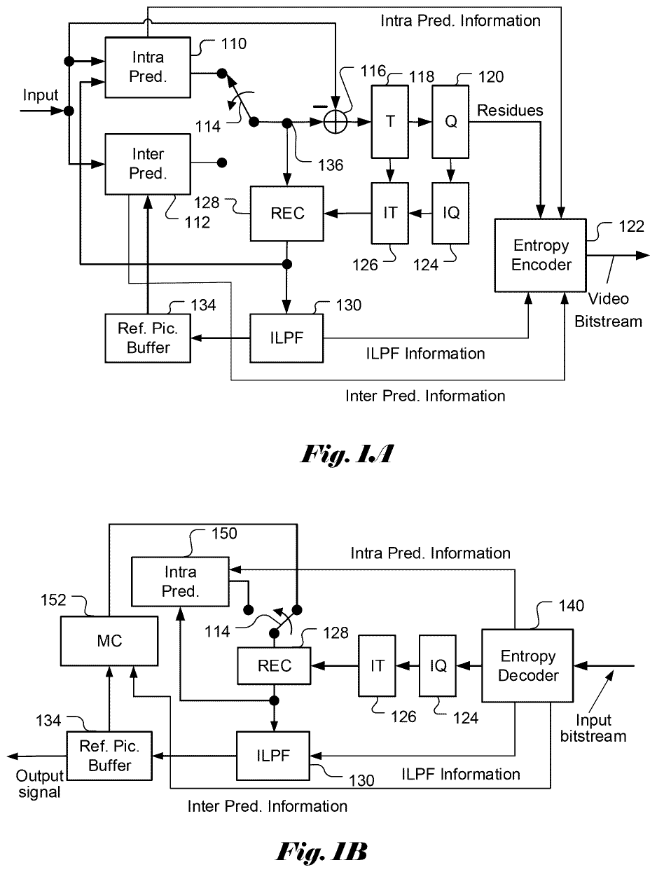

The cross-component prediction by blending multiple hypothesis of cross-component prediction models as described above can be implemented in an encoder side or a decoder side. For example, any of the proposed method can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed cross-component prediction by blending multiple hypothesis of cross-component prediction models can also be implemented as a circuit coupled to the intra/inter coding module at the decoder or the encoder. However, the decoder or encoder may also use additional processing unit to implement the required cross-component prediction processing. While the Intra Pred./MC units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

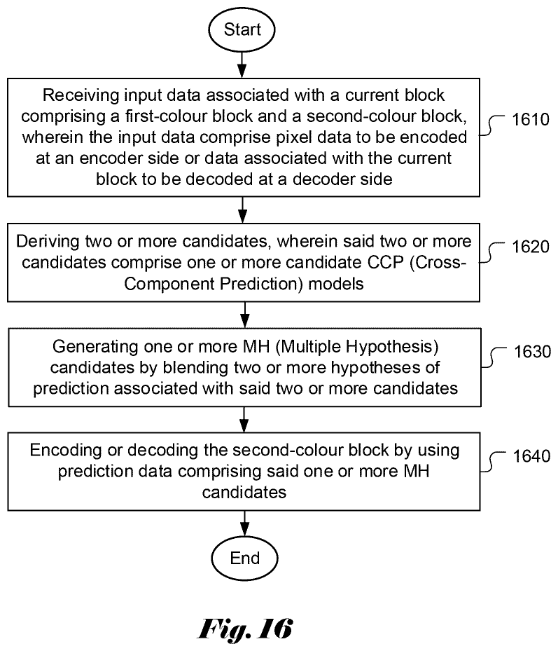

FIG. 16 illustrates a flowchart of an exemplary video coding system that incorporates multiple hypotheses of cross-component prediction models according to an embodiment of the present invention. The steps shown in the flowchart may be implemented as program codes executable on one or more processors (e.g., one or more CPUs) at the encoder or decoder side. The steps shown in the flowchart may also be implemented based hardware such as one or more electronic devices or processors arranged to perform the steps in the flowchart. According to this method, input data associated with a current block comprising a first-colour block and a second-colour block is received in step 1610, wherein the input data comprise pixel data to be encoded at an encoder side or data associated with the current block to be decoded at a decoder side. Two or more candidates are derived in step 1620, wherein said two or more candidates comprises one or more candidate CCP (Cross-Component Prediction) models. One or more MH (Multiple Hypothesis) candidates are generated by blending two or more hypotheses of prediction associated with said two or more candidates in step 1630. The second-colour block is encoded or decoded by using prediction data comprising said one or more MH candidates in step 1640.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
deriving two or more candidates, wherein said two or more candidates comprises one or more candidate CCP (Cross-Component Prediction) models;
generating one or more MH (Multiple Hypothesis) candidates by blending two or more hypotheses of prediction associated with said two or more candidates; and
encoding or decoding the second-colour block by using prediction data comprising said one or more MH candidates.

2. The method of claim 1, wherein one or more hypotheses of prediction with smaller template costs are selected from two or more candidate hypotheses of prediction as one or more of said two or more hypotheses of predictions associated with said two or more candidates.

3. The method of claim 1, wherein said two or more hypotheses of prediction associated with said two or more candidates are blended using a weighting scheme.

4. The method of claim 3, wherein the weighting scheme depends on template costs of said two or more hypotheses of prediction associated with said two or more candidates.

5. The method of claim 4, wherein one hypothesis of prediction with smaller template cost is assigned a higher weighting.

6. The method of claim 4, wherein weights for the weighting scheme are calculated using a lookup table.

7. The method of claim 3, wherein when said two or more hypotheses of prediction are selected from different template regions, the weighting scheme depends on positions of different samples.

8. The method of claim 7, wherein a current sample in the current block derives own weighting scheme for said two or more hypotheses of prediction depending on a distance between a target template region and the current sample.

9. The method of claim 7, wherein when a current sample is closer to a top template or a left template, a target hypothesis of prediction suggested by the top template or the left template respectively gets a higher weight.

10. The method of claim 7, wherein when one of said two or more hypotheses of prediction has a large template cost, position-dependent weighting is further adjusted to reduce a weight for said one of said two or more hypotheses of prediction with the large template cost.

11. The method of claim 1, wherein whether to generate said one or more MH candidates for encoding or decoding depends on one or more enabling conditions.

12. The method of claim 11, wherein when said one or more enabling conditions are not satisfied, only one of said two or more hypotheses of prediction is used to form prediction data for the second-colour block.

13. The method of claim 1, wherein one MH candidate is used as an intra prediction.

14. The method of claim 13, wherein when a value of said one MH candidate for the intra prediction exceeds a sample range, the value of said one MH candidate for the intra prediction is clipped to be within the sample range.

15. The method of claim 14, wherein weighting used to form said one MH candidate for the intra prediction follows the weighting for TIMD (Template-based Intra Mode Derivation).

16. The method of claim 14, wherein said one MH candidate for the intra prediction is further combined with an inter prediction.

17. The method of claim 13, wherein when a value of said one MH candidate for the intra prediction exceeds a sample range, the value of said one MH candidate for the intra prediction is not clipped to be within the sample range.

18. The method of claim 17, wherein said one MH candidate for the intra prediction is further combined with an inter prediction to form a combined prediction.

19. The method of claim 18, wherein the combined prediction is clipped to be within the sample range.

20. The method of claim 1, wherein decision on whether to apply inter CCLM or inter CCCM is separate for List0 prediction and List1 prediction of bi-prediction block.

21. The method of claim 1, wherein selection from said two or more hypotheses of prediction is separate for List0 prediction and List1 prediction of bi-prediction block.

22. The method of claim 1, wherein when OBMC mode is applied to the current block and if a neighbouring block of the current block is coded by any mode from cross-component modes and motion-compensated predictors, one or more of said two or more hypotheses of prediction are generated by using the cross-component modes of the neighbouring block to adjust predictors of the current block following the OBMC mode.

23. The method of claim 1, wherein when the one or more candidate CCP models belong to one or more specific CCP models, costs for the one or more candidate CCP models are adjusted by increasing or decreasing the costs of the one or more candidate CCP models.

24. The method of claim 23, wherein the one or more specific CCP models comprise GLM modes, any subset of GLM (Gradient Linear Model) modes, MDF (Multiple Downsampling Filters) modes, any subset of MDF modes, any combination thereof, or any subset of cross-component modes for intra prediction.

25. The method of claim 24, wherein the costs are increased by adding a positive offset or scaling by a factor larger than 1.

26. The method of claim 23, wherein the one or more specific CCP models comprise one or more modes using non-down-sampled luma reference samples, CCRM (Cross-Component Residual Model), CCLM (Cross-Component Linear Model), MMLM (Multiple Model CCLM), any combination thereof, or any subset of cross-component modes for intra prediction.

27. The method of claim 26, wherein the costs are decreased by subtracting a positive offset or scaling by a factor smaller than 1.

28. The method of claim 23, wherein after the costs for the one or more candidate CCP models belonging to the one or more specific CCP models are adjusted, order of the one or more candidate CCP models belonging to the one or more specific CCP models in a list comprising said two or more candidates are adjusted based on adjusted costs for the one or more candidate CCP models belonging to the one or more specific CCP models to derive said two or more candidates.

29. The method of claim 1, wherein when the current block is inter coded, one or more specific CCP models are not allowed to be taken as any of the two or more candidates.

30. The method of claim 29, wherein the one or more specific CCP models comprise GLM modes, any subset of GLM (Gradient Linear Model) modes, MDF (Multiple Downsampling Filters) modes, any subset of MDF modes, any combination thereof, or any subset of cross-component modes for intra prediction.

31. The method of claim 1, wherein when the current block is inter coded, one or more specific CCP models are allowed to be taken as any of the two or more candidates.

32. The method of claim 31, wherein the one or more specific CCP models comprise one or more modes using non-down-sampled luma reference samples, CCRM (Cross-Component Residual Model), CCLM (Cross-Component Linear Model), MMLM (Multiple Model CCLM), any combination thereof, or any subset of cross-component modes for intra prediction.

33. An apparatus for coding colour pictures or video using coding tools including one or more cross component models related modes, the apparatus comprising one or more electronic circuits or processors arranged to:
receive input data associated with a current block comprising a first-colour block and a second-colour block, wherein the input data comprise pixel data to be encoded at an encoder side or data associated with the current block to be decoded at a decoder side;
derive two or more candidates, wherein said two or more candidates comprise one or more candidate CCP (Cross-Component Prediction) models;
generate one or more MH (Multiple Hypothesis) candidates by blending two or more hypotheses of prediction associated with said two or more candidates; and
encode or decode the second-colour block by using prediction data comprising said one or more MH candidates.
